(19) United States
(12) Patent Application Publication
(10) Pub. No.: US 2026/0154608 A1
(43) Pub. Date: Jun. 4, 2026

(54) FEATURE-BASED FEEDBACK EVALUATION OF AN ARTIFICIAL INTELLIGENCE SYSTEM

(71) Applicant: Microsoft Technology Licensing, LLC, Redmond, WA (US)

(72) Inventors: Laurent BOUÉ, Petah Tikva (IL); Kiran RAMA, Bangalore (IN); Swarnim NARAYAN, Bangalore (IN); Naveen PANWAR, Bangalore (IN)

(21) Appl. No.: 18/965,335

(22) Filed: Dec. 2, 2024

(51) Int. Cl. G06N 20/00; G06F 18/213

(52) U.S. Cl. CPC G06N 20/00; G06F 18/213

(57) ABSTRACT

A process evaluates an AI assistant by collecting feedback tuples and a list of topics of the artificial intelligence assistant, wherein each feedback tuple include a question, a corresponding answer generated by the artificial intelligence assistant, and qualitative feedback corresponding to the question and the corresponding answer. A few-shot classifier outputs derived feature data. The process generates a feature-target training dataset by combining multiple derived features with metafeatures corresponding to each question-answer pair of the derived feature data and adding a quantitative feedback target corresponding to each question-answer pair of the derived feature data, and trains an attribution model using the feature-target training dataset to yield a trained attribution model. The process extracts feature importance vectors from the trained attribution model. Each feature importance vector indicates a relative importance of a given feature of the feature-target training dataset on a corresponding target of the feature-target training dataset.

### BACKGROUND

The deployment of artificial intelligence assistant systems is expected to trigger a productivity boom. Unfortunately, assessing the performance of such systems presents challenges because the tasks these systems are intended to solve tend to be very context-dependent, unsupervised, and generally lacking in ground truths.

### SUMMARY

In some aspects, the techniques described herein relate to a computerized method of evaluating an artificial intelligence assistant, the computerized method including: collecting feedback tuples and a list of topics of the artificial intelligence assistant, wherein each feedback tuple include a question, a corresponding answer generated by the artificial intelligence assistant, and qualitative feedback corresponding to the question and the corresponding answer; inputting, to a few-shot classifier, the feedback tuples, the list of topics, and a few-shot prompt; outputting, from the few-shot classifier, derived feature data including multiple derived features, after inputting the feedback tuples, the list of topics, and the few-shot prompt to the few-shot classifier; generating a feature-target training dataset by combining the multiple derived features with metafeatures corresponding to each question-answer pair of the derived feature data and adding a quantitative feedback target corresponding to each question-answer pair of the derived feature data; generating an attribution model by training the attribution model using the feature-target training dataset to yield a trained attribution model; and extracting feature importance vectors from the trained attribution model, wherein each feature importance vector indicates a relative importance of a given feature of the feature-target training dataset on a corresponding target of the feature-target training dataset.

In some aspects, the techniques described herein relate to a computerized system for evaluating an artificial intelligence assistant, the computerized system including: one or more hardware processors; memory; a few-shot classifier executable by the one or more hardware processors and configured to receive, into the memory, feedback tuples, a list of topics of the artificial intelligence assistant, and a few-shot prompt, wherein each feedback tuple include a question, a corresponding answer generated by the artificial intelligence assistant, and qualitative feedback corresponding to the question and the corresponding answer, the few-shot classifier being further configured to output derived feature data including multiple derived features, after inputting the feedback tuples, the list of topics, and the few-shot prompt to the few-shot classifier; a quantitative feature characterizer executable by the one or more hardware processors and configured to generate a feature-target training dataset by combining the multiple derived features with metafeatures corresponding to each question-answer pair of the derived feature data and adding a quantitative feedback target corresponding to each question-answer pair of the derived feature data; a model trainer executable by the one or more hardware processors and configured to generate an attribution model by training the attribution model using the feature-target training dataset to yield a trained attribution model; and a feature importance extractor executable by the one or more hardware processors and configured to extract feature importance vectors from the trained attribution model, wherein each feature importance vector indicates a relative importance of a given feature of the feature-target training dataset on a corresponding target of the feature-target training dataset.

In some aspects, the techniques described herein relate to one or more tangible processor-readable storage media embodied with instructions for executing on one or more processors and circuits of a computing device a process for evaluating an artificial intelligence assistant, the process including: collecting feedback tuples and a list of topics of the artificial intelligence assistant, wherein each feedback tuple include a question, a corresponding answer generated by the artificial intelligence assistant, and qualitative feedback corresponding to the question and the corresponding answer; outputting, from a few-shot classifier, derived feature data including multiple derived features, after inputting the feedback tuples, the list of topics, and a few-shot prompt to the few-shot classifier; generating a feature-target training dataset by combining the multiple derived features with metafeatures corresponding to each question-answer pair of the derived feature data and adding a quantitative feedback target corresponding to each question-answer pair of the derived feature data; generating an attribution model by training the attribution model using the feature-target training dataset to yield a trained attribution model; and extracting feature importance vectors from the trained attribution model, wherein each feature importance vector indicates a relative importance of a given feature of the feature-target training dataset on a corresponding target of the feature-target training dataset.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

Other implementations are also described and recited herein.

### BRIEF DESCRIPTIONS OF THE DRAWINGS

FIG. 1 illustrates an example feature-based feedback evaluator.

FIG. 2 illustrates example components of an example feature-based feedback evaluator.

FIG. 3 illustrates a detailed system for generating attribution model training data (e.g., stored in a feature-target datastore) used to evaluate the performance of an AI assistant.

FIG. 4 illustrates an example system for ranking feature importance in a trained attribution model that has been trained by the training data of a feature-target datastore.

FIG. 5 illustrates example operations for evaluating an AI assistant.

FIG. 6 illustrates an example computing device for use in implementing the described technology.

### DETAILED DESCRIPTIONS

Artificial intelligence assistant systems (AI assistants) are being deployed into mobile devices, computing workstations, industrial and medical computing devices, websites, and many other environments. For example, many AI assistants are currently available to summarize a document or webpage, to capture and summarize action items, to revise provided text, etc. However, collecting relevant feedback and mapping such feedback to specific features of the AI assistant in order to assess and improve those features is an unresolved challenge. Typically, existing feedback mechanisms are directed to a user's satisfaction with the AI assistant in general rather than specific features of the AI assistant.

The described technology programmatically identifies which features of an AI assistant are most influential over end-to-end user satisfaction by building an attribution model trained on collected performance feedback and telemetry, wherein the innovative features are derived from monitored interactions with the AI assistant. In various implementations, the skills (e.g., providing information in response to prompts and queries, summarizing or generating text in a document, generating images and/or audio content, searching the Web, and helping with productivity tasks) for which the AI assistant is trained and the associated topics (e.g., “Sales Reporting,” “Licensing,” “Summarization,” “Account Information”) are considered in the context of performance feedback using an attribution model to predict a ranking of influential features.

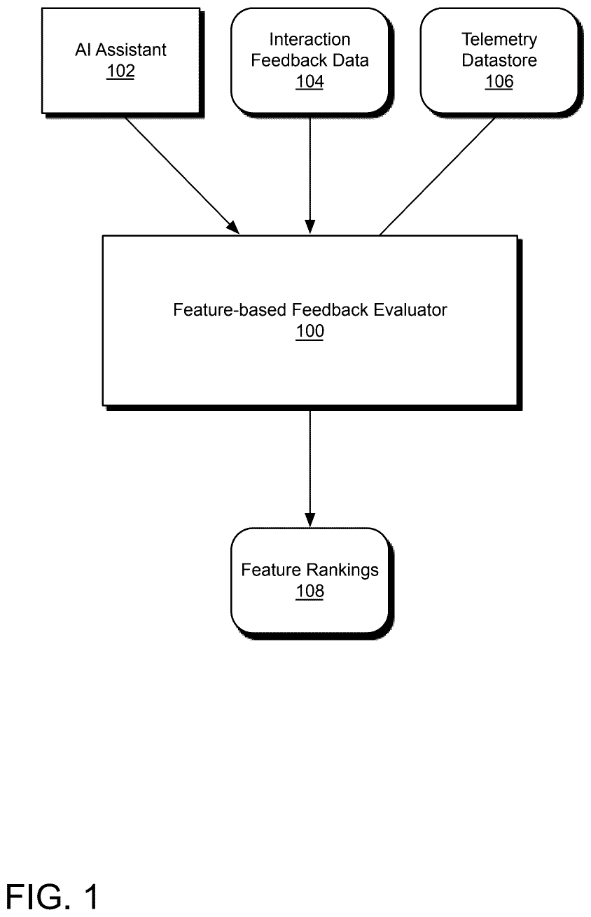

FIG. 1 illustrates an example feature-based feedback evaluator 100. In various implementations, an AI assistant 102 is an interactive service that includes one or more generative AI models. The AI assistant 102 provides a set of skills, where a “skill” refers to a specific capability or function (e.g., supported by the one or more generative AI models) that AI assistant 102 can perform to assist users. A bot is an app that users interact with in a conversational way using text, graphics, speech, etc. Accordingly, in some implementations, a skill is a bot that can perform a set of tasks for another bot-a bot can be both a skill and a user-facing bot. These skills can include, without limitation, providing information in response to prompts and queries, summarizing or generating text in a document, generating images and/or audio content, searching the Web, and helping with productivity tasks like scheduling meetings, drafting emails, or generating reports. Essentially, skills embody operations that the AI assistant 102 can perform for a user.

In some implementations, the skills supported by an AI assistant are recorded in a skill manifest (e.g., a JSON file that describes the actions the skill can perform, its input parameters, its output parameters, and the skill's endpoints. Developers who do not have access to a skill's source code can use the information in the skill manifest to design their skill consumer (e.g., another bot that interacts with the skill).

In some implementations, a skill is instrumented with a list of “topics” in a given domain for performing the specific operations implementing the skill. Topics are the building blocks of an AI assistant. Topics can be seen as the AI assistant competencies: they represent a subject around which content is organized and generated. Each topic contains conversational nodes that define how a conversation dialog is executed. Topics, therefore, include discrete conversation paths that, when used together, allow users to have a conversation that feels natural and flows appropriately. For example, “summarizing text” could be a “skill” of the AI assistant 102, which is instrumented by “topics,” such as a conversational dialog interface receiving a prompt to summarize provided text, to refine a summary based on user input, to regenerate a new summary in a different style, etc.

In various implementations, the skills supported by the AI assistant 102 can be extracted from a skills manifest available from or via the AI assistant 102. The skills manifest may be accessed in various ways, including without limitation in metadata or a configuration file associated with the AI assistant 102, via an application programming interface (API) supported by the AI assistant 102, via an extraction service that supports accessing the skills manifest of the AI assistant 102. The extracted skills and topics are input to the feature-based feedback evaluator 100.

Interaction feedback data 104 is collected, such as from a user via a user interface. Interaction feedback data 104 may include, without limitation, quantitative feedback, such as thumbs up (positive) feedback, a thumbs down (negative) feedback, a numerical rating (e.g., between 1 and 10), and (2) free text feedback (e.g., a textual comment characterizing a user's approval and/or disapproval of a generated result, such as an answer, image, summary, etc.). Other interaction feedback data may be collected and applied in the described technology.

In addition, telemetry data 106 is also collected and input to the feature-based feedback evaluator 100. Telemetry is the dynamic process of collecting, measuring, and relaying software usage and user data (e.g., user behavior) from the AI assistant 102 to a central hub for analysis. In some implementations, the feature-based feedback evaluator 100 acts as one such central hub. The telemetry data 106 provides insights into the operation of the AI assistant 102 and may include, without limitation, one or more of the following:
Logged messages and events sent to and from a skill.
Topics to be triggered during user interaction.
Custom telemetry events that can be sent from customized topics.

Telemetry data generally refers to technical metrics sourced from various hardware and software “sensors” residing in and around the AI assistant 102. These sensors collect and measure operational data about the AI assistant 102. The telemetry data 106 is passed to the AI assistant 102 to evaluate the AI assistant 102. Technical metrics relating to computational aspects of the AI assistant 102 may include, without limitation, one or more of the following: response time (e.g., the time between the input of the question and the output of the response), the number of questions asked during the current AI assistant session, the number of questions asked during the historical AI assistant sessions, and the skill invoked for the question.

In summary, interaction feedback relates to the performance of the AI assistant 102 in generating a satisfactory response, such as a question, a corresponding generated answer, and feedback corresponding to that question/answer pair. In some implementations, the feedback can be in the form of (1) rating feedback characterizing the performance of a particular skill and/or topic of the AI assistant 102, such as thumbs up (positive) feedback, a thumbs down (negative) feedback, a numerical rating (e.g., between 1 and 10), and (2) free text feedback (e.g., a textual comment characterizing a user's approval and/or disapproval of a generated result, such as an answer, image, summary, etc.). In contrast, telemetry data refers to technical metrics relating to computational aspects of the AI assistant 102, including, without limitation, one or more of the following: response time (e.g., the time between the input of the question and the output of the response), the number of questions asked during the current AI assistant session, the number of questions asked during the historical AI assistant sessions, and the skill invoked for the question.

The feature-based feedback evaluator 100 receives as input the AI assistant 102, the interaction feedback data 104, and the telemetry data 106 and derives features of the AI assistant 102 using free text feedback. The feature-based feedback evaluator 100 also supplements the derived features with quantitative feedback data (e.g., thumbs up/down) from interaction feedback data 104 and telemetry data 106 to generate training data for an attribution model. After the attribution model has been trained with the training data, the feature-based feedback evaluator 100 extracts ranked feature importance ratings from the attribution model to yield feature rankings 108 for the AI assistant 102. In one example, the feature rankings 108 identifies a ranking of the relative importance a given feature (e.g., topic, skill, response time, session time, number of interactions) is to user satisfaction with the AI assistant 102.

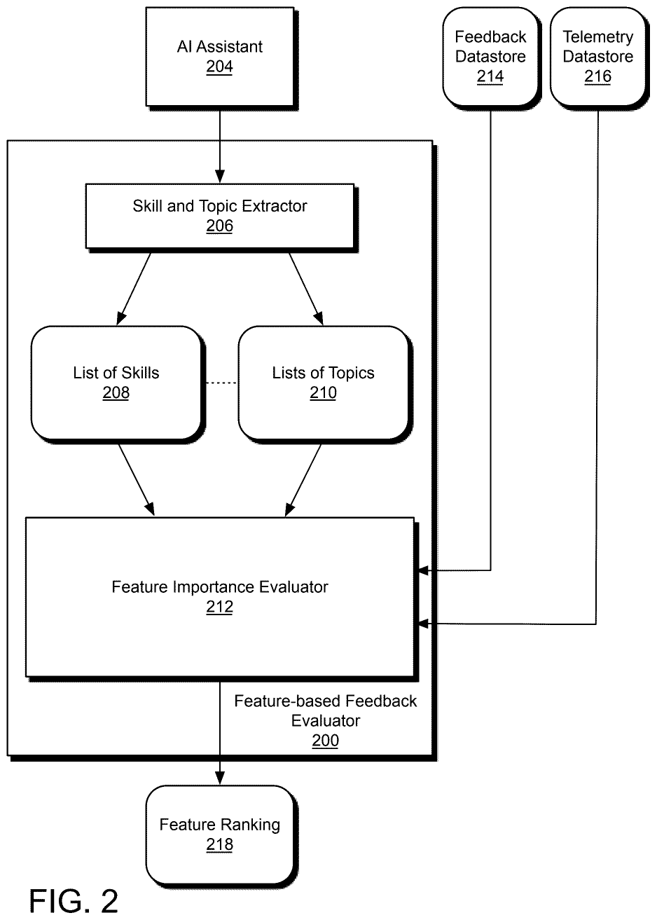

FIG. 2 illustrates example components of an example feature-based feedback evaluator 200. An AI assistant 204 supports multiple skills (as defined above), each skill being instrumented by one or more topics (as defined above). Logically, the AI assistant 204 is referenced as C with a list of N skills, such that C=[s₁, s₂, s₃, . . . s_{N}], although it should be understood that the AI assistant 204 may comprise more than just the listed set of skills. Each skill s can itself be summarized by a list of nti topics (sᵢ=tᵢ_{₁}, tᵢ_{₂}, tᵢ_{₃}, . . . tᵢ_{ₙₜᵢ}), wherein each topic describes the types of conversational dialogs the skill is trained to handle. A concatenation of the topics instrumenting a given skill is denoted as Lt.

A skill and topic extractor 206 identifies a list of skills 208 supported by the AI assistant 204 (e.g., by reading the list of skills from a skill manifest). Other techniques may be employed to identify the list of skills 208. The skill and topic extractor 206 also identifies a list of topics 210 for each skill identified in the list of skills 208 (e.g., by reading training materials, industry publications, community databases, and other documentation related to each skill). In some implementations, the skill and topic extractor 206 may query the AI assistant 204 (e.g., through an API) to extract the list of topics 210 for each identified skill. In some implementations, the topics associated with a given skill may be determined by invoking a classification query to a pre-trained LLM. An example of such topic extraction is described below, with reference to submitting a few shot prompt to a few shot classification LLM, as described with respect to the “two main tasks” in the few shot prompt example given below. A correspondence between the skills and their corresponding topics is indicated by the dotted line between the list of skills 208 and the list of topics 210, which are passed to a feature importance evaluator 212 to identify and rank the features of the AI assistant 204.

In addition to the list of skills 208 and the list of topics 210, the feature importance evaluator 212 also receives feedback data from a feedback datastore 214, which stores question/answer pairs and additional feedback information about the users' interactions with the AI assistant 204. Such feedback information may include, without limitation:
Qualitative feedback, such as free-text comments describing how the user feels about the answers provided by the AI assistant 204
Quantitative feedback, such as a thumbs up/down, a 1-5 rating, etc.

In the examples provided below, the thumbs up/down is described as a target of a model trainer (see, e.g., the model trainer 406) that is used to train an attribution model (see, e.g., trained attribution model 402). However, the model trainer can process another target, such as a numerical rating (e.g., 1-5) or a Likert scale or can process multiple targets (e.g., a thumbs up/down and a 1-5 rating), although some implementations of multiple targets may use an additional aggregation mechanism to reduce the multiple targets to a single target before the describe feature importance techniques are described.

In various implementations, the qualitative interaction feedback (e.g., free text feedback) may be represented in a tuple of data (deemed a “feedback tuple” and often represented in the form of a JSON object) including the corresponding question/answer pair, an example of which is given below:

(questionᵢ,answerᵢ,free−text feedbackᵢ)

The feature importance evaluator 212 uses this free-text feedback to determine an efficacy score for the AI assistant's performance in generating the answer from the question, wherein performance can reflect the satisfaction of the user with the answer, as specified in the free-text feedback. In one implementation, the efficacy score is generated using a few-shot classification performed by a large language model (LLM) to quantifiably measure the quality of the answer based on the free-text feedback provided by the user for the corresponding topic. An example prompt provided to the LLM in the few-shot classification is provided below:
As an AI system, you are designed with the following functionalities:
   You assist users in understanding a question-answering system.
   You have two main tasks:
1. Identify the topics of a series of question-and-answer pairs based on their content.
2. Provide an efficacy score for the feedback received from users on the answers.
   The categories for identifying the topics of the Q&A pairs are as follows: [“Sales Reporting”, “Licensing”,
“Summarization”, “Account Information”]
   Along with the Q&A pairs, you will also receive user feedback.
   Based on this feedback, you are required to evaluate the quality of the answers.
   You will assign an efficacy score ranging from 1 to 5, where:
   Score 5: The answer is correct, comprehensive, and the user is fully satisfied.
   Score 4: The answer is correct, but lacks some minor details. The user is mostly satisfied.
   Score 3: The answer is partially correct, missing some key points. The user is somewhat satisfied.
   Score 2: The answer is mostly incorrect, with only a few correct points. The user is not very satisfied.
   Score 1: The answer is incorrect or irrelevant. The user is not satisfied at all.
   You will be given an input in the form of a JSON object with the keys ‘question’, ‘answer’, and ‘feedback’.
   Your output will be a JSON object with keys ‘Topic’ and ‘Efficacy Score’.
   Your ultimate goal is to help improve the system's performance by analyzing the feedback and providing
an accurate topic and efficacy score.

```
  **For example:**
  Input:
  {
  “question”: “How can I generate a sales report for the last quarter?”,
  “answer”: “You can generate a sales report by going to the ‘Reports'
  section and selecting ‘Sales Report’.
  Then, set the date range for the last quarter and click ‘Generate’.”,
  “feedback”: “The answer was very helpful and detailed. I was able to
  generate the report successfully.”
  }
  Output:
  {
  “Topic”: “Sales Reporting”,
  “Efficacy Score”: 5
  }
  **Another example:**
  Input:
  {
  “question”: “What is the process to renew my software license?”,
  “answer”: “To renew your software license, go to the ‘Account’ section
  and click on ‘Licenses'. Here, you can see the ‘Renew’ option next to
  your software license.”,
  “feedback”: “The answer was correct, but I had trouble finding the
  ‘Licenses' section.
  A more detailed explanation would have been helpful.”
  }
  Output:
  {
  “Topic”: “Licensing”,
  “Efficacy Score”: 3
}
```

### Listing 1—an Example Few-Shot Prompt

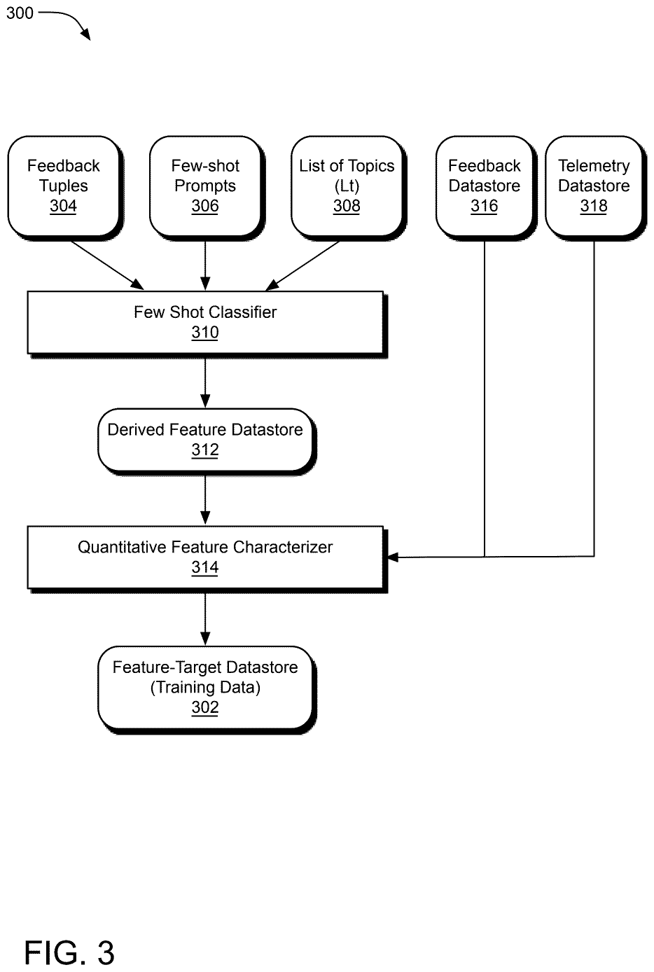

By inputting a prompt like the example prompt provided above, a few-shot classifier (see the few-shot classifier 310 in FIG. 3) generates a topic-efficacy score pair as output in correspondence with each question-answer pair, yielding efficacy output in the example form:

(questionᵢ,answerᵢ),topic,efficacy score

Generally, the efficacy scores constitute “derived features” that assess the performance of each question/answer pair. The efficacy score is a quantitative measure of the satisfaction of the user over the session with the AI assistant 204, although alternative or additional measures may be employed. For example, the efficacy score may be accompanied by additional metrics, such as sentiment scores generated from the user's verbatim feedback as assessed by another classification model and/or historical statistics of quantitative feedback rates (e.g., damped average). Such additional metrics can be added to a derived feature datastore (e.g., a derived feature table), an example of which is shown below in Table 1 for the basic question, answer, topic, and efficacy score result (e.g., “derived features”), where q denotes a question, a denotes an answer, t denotes a topic, and s represents an efficacy score.

TABLE 1
Derived Feature Table

| Question/Answer | Topic | Efficacy Score |
|---|---|---|
| (q₁, a₁) | t₁ | s₁ |
| (q₂, a₂) | t₂ | s₂ |
| . . . | . . . | . . . |

Each question-answer pair (qᵢ, aᵢ) is also associated with other metadata received from a telemetry datastore 216, wherein each feature is termed a “metafeature.” Such metadata may include, without limitation, features such as:
Question-answer response time.
The AI assistant skill(s) invoked by the planner/orchestrator handling the question.
The number of historical interactions between the skill and the user
User demographics
Browser-related information
Enterprise/organizational information

Note that each of these telemetry features may be associated with numerous fields, including, without limitation, geolocation, session duration, screen resolution, language preferences, and time zone. A vector (“metavector”) of such metadata features is denoted as Mᵢ=[M1ᵢ, M2ᵢ, M3ᵢ . . . ], wherein each element corresponds to a metafeature. Note that the list of skills 208 represents the list of skills supported by the AI assistant 204, whereas the AI assistant skill included as a metafeature (see the list above) represents one or more skills invoked in the AI assistant when handling a question.

The metavector and the quantitative feedback corresponding to each question-answer pair are input to a qualitative feature characterizer in the feature importance evaluator 212, which adds the metavector and the quantitative feedback to the corresponding question-answer, efficacy score tuple in the derived features data to yield attribution model training data, as shown below in an example feature-target table (e.g., a feature-target datastore).

TABLE 2
Feature-Target Table

| | | | | | | Thumbs |
|---|---|---|---|---|---|---|
| Question/ | | Efficacy | | | | up/down |
| Answer | Topic | Score | M1 | M2 | . . . | target |
| (q₁, a₁) | t₁ | s₁ | M1₁ | M2₁ | . . . | Target₁ |
| (q₂, a₂) | t₂ | s₂ | M1₂ | M2₂ | . . . | Target₂ |
| . . . | . . . | . . . | . . . | . . . | . . . | . . . |

An artificial intelligence attribution model is trained using the attribution model training data (e.g., stored in a feature-target table). The features of the training data include the topic, the efficacy score, and the metafeatures, and the target of the training data includes the quantitative data (e.g., the thumbs up/down indication by the user). The resulting trained attribution model is denoted as M_{{attribution}}.

The relative importance of each feature of the trained attribution model can be extracted using techniques such as SHAP (SHapley Addictive explanations), LIME (Local Interpretable Model-agnostic Explanations), and other kinds of permutation testing. Such techniques can interpret the inner workings of a machine learning model, which is effectively a black box with respect to external observations, and further can explain the model's decisions in order to rank the relative importance of each feature of the trained attribution model, which are output from the feature-based feedback evaluator 200 as feature ranking 218. In one example, the feature ranking 218 identifies a ranking of the relative importance a given feature (e.g., topic, skill, response time, session time, number of interactions) is to user satisfaction with the AI assistant 204 (e.g., based on both qualitative and quantitative feedback from a user).

FIG. 3 illustrates a detailed system 300 for generating attribution model training data (e.g., stored in a feature-target datastore 302) used to evaluate the performance of an AI assistant. Feedback tuples 304 (e.g., (questionᵢ,answerᵢ,free−text feedbackᵢ)), few-shot prompts 306, and the list of topics 308 (Lt) are input to a few-shot classifier 310. A few-shot prompt includes a small set of multiple examples to guide a machine learning model's behavior for a particular task. For example, the prompt from Listing 1 includes two examples:
(1) Input relating to “question”: “How can I generate a sales report for the last quarter?” and its corresponding answer, feedback, and corresponding output “(topic, efficacy score)”
(2) Input relating to “question”: “What is the process to renew my software license?” and its corresponding answer and feedback, and corresponding output “(topic, efficacy score)”

In some implementations, such as shown in the prompt above, the few-shot prompt also provides a mapping of feedback to a given efficacy score (e.g., “Score 2: The answer is mostly incorrect, with only a few correct points. The user is not very satisfied). The output of the few-shot classifier 310 is a derived feature datastore 312, including a question-answer pair, a corresponding topic, and a corresponding efficacy score (see the example Derived Feature Table in Table 2).

In various implementations, a few-shot classifier based on a large language model (LLM) identifies the corresponding class by leveraging its pre-trained knowledge and the context provided in the prompt. For example, the prompt includes:
Few labeled examples (the “few-shot” examples): Each example consists of a short description or input paired with its correct label.
Query input: The new input for which the LLM needs to classify

Generally these models are successful because of this in-context learning, where few-shot examples guide the model to focus on relevant patterns for the specific classification task. As such, LLMs can generalize from minimal examples due to extensive training on diverse datasets.

The derived feature datastore 312 is input to a quantitative feature characterizer 314, which also inputs data quantitative feedback from a feedback datastore 316 and metafeatures from a telemetry datastore 318. These data are combined by the quantitative feature characterizer 314 into the feature-target datastore 302, an example of which is shown in Table 2, to be used as training data for an attribution model.

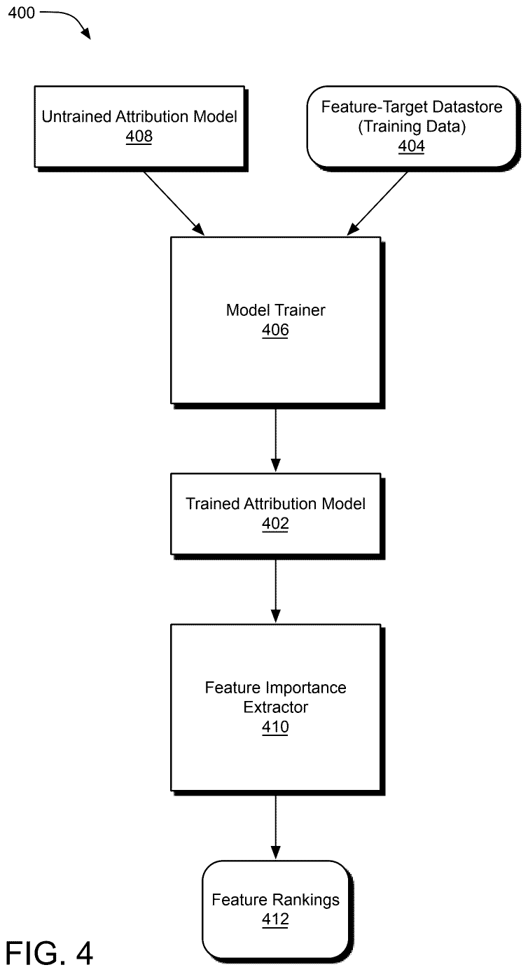

FIG. 4 illustrates an example system 400 for ranking features importance in a trained attribution model 402 that has been trained by the training data of a feature-target datastore 404. An artificial intelligence model trainer 406 trains an untrained attribution model 408 using the feature-target datastore 404 to yield the trained attribution model 402.

A feature importance extractor 410 extracts feature importance vectors from the trained attribution model 402 using an explanation technique. In one implementation, an explanation tool, such as SHAP (SHapley Additive explanations), LIME (Local Interpretable Model-agnostic Explanations), or some other kind of permutation test. SHAP, for example, assists in interpreting machine learning models with Shapely values, which are measures of the contributions each feature (predictor) has in a machine learning model. In one view, Shapely values are measures of how important a specific feature is to the predictions made by the model. Generally, a feature importance matrix represents a datastore in which each feature is associated with a measurement or score that indicates its relative importance to the decisions made during prediction by the target machine learning model, which, in the described technology, includes an attribution model trained using question-answer pairs, derived features from qualitative feedback, metafeatures from telemetry, and quantitative feedback targets. In some implementations, the features in the feature importance matrix can be ranked based on the measurement or score associated with each feature.

Accordingly, the relative importance of each feature to each other feature in the feature-target datastore is ranked (e.g., from most positive importance to most negative importance) and output as feature rankings 412. In one implementation, the feature rankings 412 identifies a ranking of the relative importance of a given feature (e.g., topic, skill, response time, session time, number of interactions) to user satisfaction with the AI assistant. For example, a most positively important feature is a feature that most impacts a positive target (e.g., a thumbs up feedback), and a most negatively important feature is a feature that most impacts a negative target (e.g., a thumbs down feedback).

An enterprise may evaluate the feature rankings to set business priorities. For example, development resources may be more heavily devoted to improving the priority of the more negatively important feature in an effort to improve overall user satisfaction. In contrast, marketing resources may be more heavily devoted to publicizing the more positively important features, and development resources may be more heavily devoted to refining the discoverability of the more positively important features.

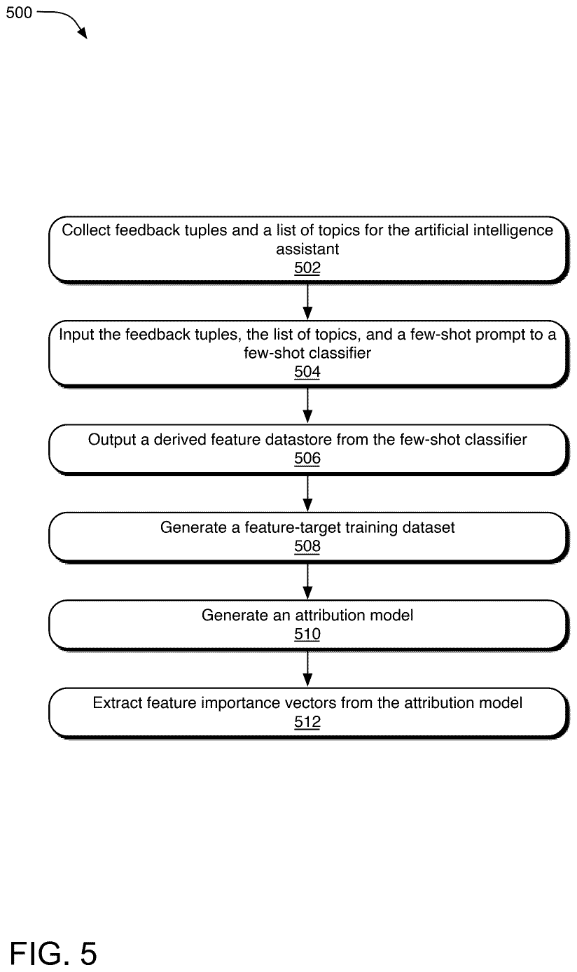

FIG. 5 illustrates example operations 500 for evaluating an AI assistant. A collection operation 502 collects feedback tuples and a list of topics of the artificial intelligence assistant. Each feedback tuple includes a question, a corresponding answer generated by the artificial intelligence assistant, and qualitative feedback corresponding to the question and the corresponding answer. In some implementations, the qualitative feedback includes free-text feedback provided by a user via a user interface, although other types of qualitative feedback may be employed.

An inputting operation 504 inputs the feedback tuples, the list of topics, and a few-shot prompt to a few-shot classifier. An outputting operation 506 outputs a derived feature datastore from the few-shot classifier after receipt of the feedback tuples, the list of topics, and the few-shot prompt to the few-shot classifier. The derived feature datastore includes multiple derived features such as a question-answer pair, a topic of the artificial intelligence assistant used to generate an answer for the question-answer pair, and an efficacy score corresponding to the answer based on the qualitative feedback. Generally, the efficacy score is generated by a few-shot classifier based on the feedback tuple and a few-shot prompt including efficacy scoring examples corresponding to example derived features.

A generation operation 508 generates a feature-target training dataset by combining the multiple derived features with metafeatures corresponding to each question-answer pair of the derived feature datastore and adding a quantitative feedback target corresponding to each question-answer pair of the derived feature datastore. Each metafeature includes telemetry data corresponding to a corresponding question-answer pair. Each quantitative feedback target provides a measurement of the performance of the AI assistant in generating the answer to the question (e.g., a thumbs up/down, a quantitative rating). The feature-target training dataset includes the multiple derived features, one or more corresponding metafeatures, and quantitative feedback.

Another generation operation 510 generates an attribution model by training the attribution model using the feature-target training dataset including derived features and metafeatures corresponding to question-answer pairs to yield a trained attribution model. Each metafeature includes telemetry data corresponding to a corresponding question-answer pair. An extracting operation 512 extracts feature importance vectors from the trained attribution model, wherein each feature importance vector indicates the relative importance of a given feature of the feature-target training dataset on a corresponding target of the feature-target training dataset.

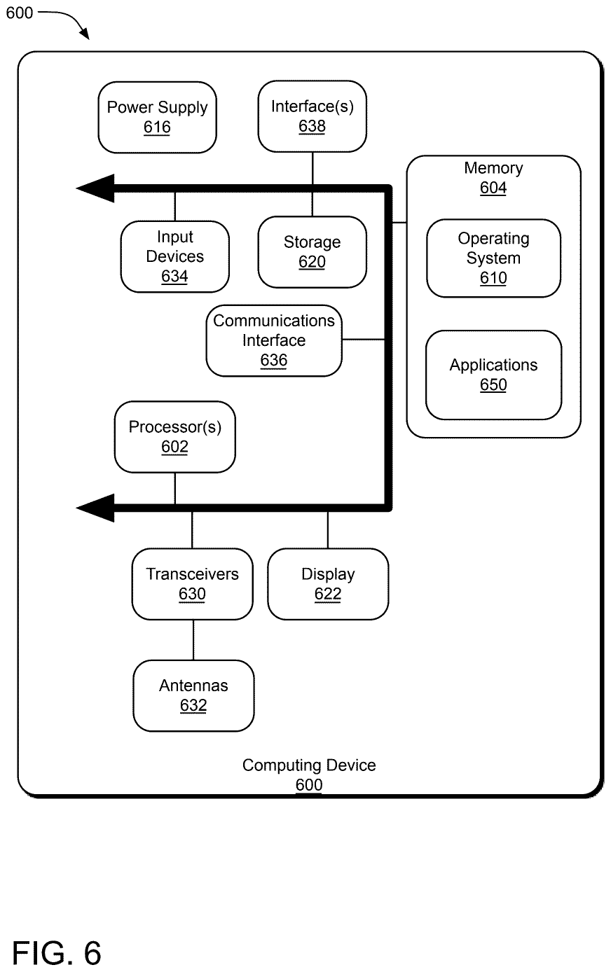

FIG. 6 illustrates an example computing device 600 for use in implementing the described technology. The computing device 600 may be a client computing device (such as a laptop computer, a desktop computer, or a tablet computer), a server/cloud computing device, an Internet-of-Things (IoT), any other type of computing device, or a combination of these options. The computing device 600 includes one or more hardware processor(s) 602 and a memory 604. The memory 604 generally includes both volatile memory (e.g., RAM) and nonvolatile memory (e.g., flash memory), although one or the other type of memory may be omitted. An operating system 610 resides in the memory 604 and is executed by the processor(s) 602. In some implementations, the computing device 600 includes and/or is communicatively coupled to storage 620.

In the example computing device 600, as shown in FIG. 6, one or more software modules, segments, and/or processors, such as applications 650, a feature-based feedback evaluator, a skill and topic extractor, a feature importance evaluator, a few shot classifier, a quantitative feature characterizer, a model trainer, a feature importance extractor, and other program code and modules are loaded into the operating system 610 on the memory 604 and/or the storage 620 and executed by the processor(s) 602. The storage 620 may store interaction feedback data, qualitative feedback (e.g., free-text feedback), quantitative feedback (e.g., thumbs up/down, a numerical rating), telemetry data, feature rankings, a list of skills, a list of topics, derived feature data, feedback tuples, few-shot prompts, feature-target training data, and other data and be local to the computing device 600 or may be remote and communicatively connected to the computing device 600. In particular, in one implementation, components of a system for evaluating an AI assistant may be implemented entirely in hardware or in a combination of hardware circuitry and software.

The computing device 600 includes a power supply 616, which may include or be connected to one or more batteries or other power sources, and which provides power to other components of the computing device 600. The power supply 616 may also be connected to an external power source that overrides or recharges the built-in batteries or other power sources.

The computing device 600 may include one or more communication transceivers 630, which may be connected to one or more antenna(s) 632 to provide network connectivity (e.g., mobile phone network, Wi-Fi®, Bluetooth®) to one or more other servers, client devices, IoT devices, and other computing and communications devices. The computing device 600 may further include a communications interface 636 (such as a network adapter or an I/O port, which are types of communication devices). The computing device 600 may use the adapter and any other types of communication devices for establishing connections over a wide-area network (WAN) or local-area network (LAN). It should be appreciated that the network connections shown are exemplary and that other communications devices and means for establishing a communications link between the computing device 600 and other devices may be used.

The computing device 600 may include one or more input devices 634 such that a user may enter commands and information (e.g., a keyboard, trackpad, or mouse). These and other input devices may be coupled to the server by one or more interfaces 638, such as a serial port interface, parallel port, or universal serial bus (USB). The computing device 600 may further include a display 622, such as a touchscreen display.

The computing device 600 may include a variety of tangible processor-readable storage media and intangible processor-readable communication signals. Tangible processor-readable storage can be embodied by any available media that can be accessed by the computing device 600 and can include both volatile and nonvolatile storage media and removable and non-removable storage media. Tangible processor-readable storage media excludes intangible and transitory communications signals (such as signals per se) and includes volatile and nonvolatile, removable and non-removable storage media implemented in any method, process, or technology for storage of information such as processor-readable instructions, data structures, program modules, or other data. Tangible processor-readable storage media includes, but is not limited to, RAM, ROM, EEPROM, flash memory or other memory technology, CDROM, digital versatile disks (DVD) or other optical disk storage, magnetic cassettes, magnetic tape, magnetic disk storage, or other magnetic storage devices, or any other tangible medium which can be used to store the desired information and which can be accessed by the computing device 600. In contrast to tangible processor-readable storage media, intangible processor-readable communication signals may embody processor-readable instructions, data structures, program modules, or other data resident in a modulated data signal, such as a carrier wave or other signal transport mechanism. The term “modulated data signal” means a signal that has one or more of its characteristics set or changed in such a manner as to encode information in the signal. By way of example, and not limitation, intangible communication signals include signals traveling through wired media such as a wired network or direct-wired connection, and wireless media such as acoustic, RF, infrared, and other wireless media.

Clause 1. A computerized method of evaluating an artificial intelligence assistant, the computerized method comprising: collecting feedback tuples and a list of topics of the artificial intelligence assistant, wherein each feedback tuple include a question, a corresponding answer generated by the artificial intelligence assistant, and qualitative feedback corresponding to the question and the corresponding answer; inputting, to a few-shot classifier, the feedback tuples, the list of topics, and a few-shot prompt; outputting, from the few-shot classifier, derived feature data including multiple derived features, after inputting the feedback tuples, the list of topics, and the few-shot prompt to the few-shot classifier; generating a feature-target training dataset by combining the multiple derived features with metafeatures corresponding to each question-answer pair of the derived feature data and adding a quantitative feedback target corresponding to each question-answer pair of the derived feature data; generating an attribution model by training the attribution model using the feature-target training dataset to yield a trained attribution model; and extracting feature importance vectors from the trained attribution model, wherein each feature importance vector indicates a relative importance of a given feature of the feature-target training dataset on a corresponding target of the feature-target training dataset.

Clause 2. The computerized method of clause 1, wherein the qualitative feedback includes free-text feedback.

Clause 3. The computerized method of clause 1, wherein the multiple derived features include a question-answer pair, a topic of the artificial intelligence assistant used to generate an answer for the question-answer pair, and an efficacy score corresponding to the answer and based on the qualitative feedback.

Clause 4. The computerized method of clause 3, wherein the efficacy score is generated using the few-shot classifier based on a feedback tuple and a few-shot prompt including efficacy scoring examples corresponding to example derived features.

Clause 5. The computerized method of clause 1, wherein the feature-target training dataset includes a derived feature of the multiple derived features, one or more corresponding metafeatures, and quantitative feedback.

Clause 6. The computerized method of clause 5, wherein the multiple derived features include a topic of the artificial intelligence assistant and an efficacy score corresponding to a corresponding question-answer pair.

Clause 7. The computerized method of clause 5, wherein each metafeature includes telemetry data corresponding to a corresponding question-answer pair.

Clause 8. A computerized system for evaluating an artificial intelligence assistant, the computerized system comprising: one or more hardware processors; memory; a few-shot classifier executable by the one or more hardware processors and configured to receive, into the memory, feedback tuples, a list of topics of the artificial intelligence assistant, and a few-shot prompt, wherein each feedback tuple include a question, a corresponding answer generated by the artificial intelligence assistant, and qualitative feedback corresponding to the question and the corresponding answer, the few-shot classifier being further configured to output derived feature data including multiple derived features, after inputting the feedback tuples, the list of topics, and the few-shot prompt to the few-shot classifier; a quantitative feature characterizer executable by the one or more hardware processors and configured to generate a feature-target training dataset by combining the multiple derived features with metafeatures corresponding to each question-answer pair of the derived feature data and adding a quantitative feedback target corresponding to each question-answer pair of the derived feature data; a model trainer executable by the one or more hardware processors and configured to generate an attribution model by training the attribution model using the feature-target training dataset to yield a trained attribution model; and a feature importance extractor executable by the one or more hardware processors and configured to extract feature importance vectors from the trained attribution model, wherein each feature importance vector indicates a relative importance of a given feature of the feature-target training dataset on a corresponding target of the feature-target training dataset.

Clause 9. The computerized system of clause 8, wherein the qualitative feedback includes free-text feedback.

Clause 10. The computerized system of clause 8, wherein the multiple derived features include a question-answer pair, a topic of the artificial intelligence assistant used to generate an answer for the question-answer pair, and an efficacy score corresponding to the answer and based on the qualitative feedback.

Clause 11. The computerized system of clause 10, wherein the efficacy score is generated by the few-shot classifier based on a feedback tuple and a few-shot prompt including efficacy scoring examples corresponding to example derived features.

Clause 12. The computerized system of clause 8, wherein the feature-target training dataset includes a derived feature of the multiple derived features, one or more corresponding metafeatures, and quantitative feedback.

Clause 13. The computerized system of clause 12, wherein the multiple derived features include a topic of the artificial intelligence assistant and an efficacy score corresponding to a corresponding question-answer pair.

Clause 14. The computerized system of clause 12, wherein each metafeature includes telemetry data corresponding to a corresponding question-answer pair.

Clause 15. One or more tangible processor-readable storage media embodied with instructions for executing on one or more processors and circuits of a computing device a process for evaluating an artificial intelligence assistant, the process comprising: collecting feedback tuples and a list of topics of the artificial intelligence assistant, wherein each feedback tuple include a question, a corresponding answer generated by the artificial intelligence assistant, and qualitative feedback corresponding to the question and the corresponding answer; outputting, from a few-shot classifier, derived feature data including multiple derived features, after inputting the feedback tuples, the list of topics, and a few-shot prompt to the few-shot classifier; generating a feature-target training dataset by combining the multiple derived features with metafeatures corresponding to each question-answer pair of the derived feature data and adding a quantitative feedback target corresponding to each question-answer pair of the derived feature data; generating an attribution model by training the attribution model using the feature-target training dataset to yield a trained attribution model; and extracting feature importance vectors from the trained attribution model, wherein each feature importance vector indicates a relative importance of a given feature of the feature-target training dataset on a corresponding target of the feature-target training dataset.

Clause 16. The one or more tangible processor-readable storage media of clause 15, wherein the multiple derived features include a question-answer pair, a topic of the artificial intelligence assistant used to generate an answer for the question-answer pair, and an efficacy score corresponding to the answer and based on the qualitative feedback.

Clause 17. The one or more tangible processor-readable storage media of clause 16, wherein the efficacy score is generated using the few-shot classifier based on a feedback tuple and a few-shot prompt including efficacy scoring examples corresponding to example derived features.

Clause 18. The one or more tangible processor-readable storage media of clause 15, wherein the feature-target training dataset includes derived features, one or more corresponding metafeatures, and quantitative feedback.

Clause 19. The one or more tangible processor-readable storage media of clause 18, wherein the multiple derived features include a topic of the artificial intelligence assistant and an efficacy score corresponding to a corresponding question-answer pair.

Clause 20. The one or more tangible processor-readable storage media of clause 18, wherein each metafeature includes telemetry data corresponding to a corresponding question-answer pair.

Clause 21. A system for evaluating an artificial intelligence assistant, the computerized method comprising: means for collecting feedback tuples and a list of topics of the artificial intelligence assistant, wherein each feedback tuple include a question, a corresponding answer generated by the artificial intelligence assistant, and qualitative feedback corresponding to the question and the corresponding answer; means for inputting, to a few-shot classifier, the feedback tuples, the list of topics, and a few-shot prompt; means for outputting, from the few-shot classifier, derived feature data including multiple derived features, after inputting the feedback tuples, the list of topics, and the few-shot prompt to the few-shot classifier; means for generating a feature-target training dataset by combining the multiple derived features with metafeatures corresponding to each question-answer pair of the derived feature data and means for adding a quantitative feedback target corresponding to each question-answer pair of the derived feature data; means for generating an attribution model by training the attribution model using the feature-target training dataset to yield a trained attribution model; and means for extracting feature importance vectors from the trained attribution model, wherein each feature importance vector indicates a relative importance of a given feature of the feature-target training dataset on a corresponding target of the feature-target training dataset.

Clause 22. The system of clause 21, wherein the qualitative feedback includes free-text feedback.

Clause 23. The system of clause 21, wherein the multiple derived features include a question-answer pair, a topic of the artificial intelligence assistant used to generate an answer for the question-answer pair, and an efficacy score corresponding to the answer and based on the qualitative feedback.

Clause 24. The system of clause 23, wherein the efficacy score is generated using the few-shot classifier based on a feedback tuple and a few-shot prompt including efficacy scoring examples corresponding to example derived features.

Clause 25. The system of clause 21, wherein the feature-target training dataset includes a derived feature of the multiple derived features, one or more corresponding metafeatures, and quantitative feedback.

Clause 26. The system of clause 25, wherein the multiple derived features include a topic of the artificial intelligence assistant and an efficacy score corresponding to a corresponding question-answer pair.

Clause 27. The system of clause 25, wherein each metafeature includes telemetry data corresponding to a corresponding question-answer pair.

Some implementations may comprise an article of manufacture, which excludes software per se. An article of manufacture may comprise a tangible storage medium to store logic and/or data. Examples of a storage medium may include one or more types of computer-readable storage media capable of storing electronic data, including volatile memory or nonvolatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, operation segments, methods, procedures, software interfaces, application program interfaces (API), instruction sets, computing code, computer code, code segments, computer code segments, words, values, symbols, or any combination thereof. In one implementation, for example, an article of manufacture may store executable computer program instructions that, when executed by a computer, cause the computer to perform methods and/or operations in accordance with the described embodiments. The executable computer program instructions may include any suitable types of code, such as source code, compiled code, interpreted code, executable code, static code, dynamic code, and the like. The executable computer program instructions may be implemented according to a predefined computer language, manner, or syntax, for instructing a computer to perform a certain operation segment. The instructions may be implemented using any suitable high-level, low-level, object-oriented, visual, compiled, and/or interpreted programming language.

The implementations described herein are implemented as logical steps in one or more computer systems. The logical operations may be implemented (1) as a sequence of processor-implemented steps executing in one or more computer systems and (2) as interconnected machine or circuit modules within one or more computer systems. The implementation is a matter of choice, dependent on the performance requirements of the computer system being utilized. Accordingly, the logical operations making up the implementations described herein are referred to variously as operations, steps, objects, or modules. Furthermore, it should be understood that logical operations may be performed in any order, unless explicitly claimed otherwise or a specific order is inherently necessitated by the claim language.

What is claimed is:

1. A computerized method of evaluating an artificial intelligence assistant, the computerized method comprising:
collecting feedback tuples and a list of topics of the artificial intelligence assistant, wherein each feedback tuple include a question, a corresponding answer generated by the artificial intelligence assistant, and qualitative feedback corresponding to the question and the corresponding answer;
inputting, to a few-shot classifier, the feedback tuples, the list of topics, and a few-shot prompt;
outputting, from the few-shot classifier, derived feature data including multiple derived features, after inputting the feedback tuples, the list of topics, and the few-shot prompt to the few-shot classifier;
generating a feature-target training dataset by combining the multiple derived features with metafeatures corresponding to each question-answer pair of the derived feature data and adding a quantitative feedback target corresponding to each question-answer pair of the derived feature data;
generating an attribution model by training the attribution model using the feature-target training dataset to yield a trained attribution model; and
extracting feature importance vectors from the trained attribution model, wherein each feature importance vector indicates a relative importance of a given feature of the feature-target training dataset on a corresponding target of the feature-target training dataset.

2. The computerized method of claim 1, wherein the qualitative feedback includes free-text feedback.

3. The computerized method of claim 1, wherein the multiple derived features include a question-answer pair, a topic of the artificial intelligence assistant used to generate an answer for the question-answer pair, and an efficacy score corresponding to the answer and based on the qualitative feedback.

4. The computerized method of claim 3, wherein the efficacy score is generated using the few-shot classifier based on a feedback tuple and a few-shot prompt including efficacy scoring examples corresponding to example derived features.

5. The computerized method of claim 1, wherein the feature-target training dataset includes a derived feature of the multiple derived features, one or more corresponding metafeatures, and quantitative feedback.

6. The computerized method of claim 5, wherein the multiple derived features include a topic of the artificial intelligence assistant and an efficacy score corresponding to a corresponding question-answer pair.

7. The computerized method of claim 5, wherein each metafeature includes telemetry data corresponding to a corresponding question-answer pair.

8. A computerized system for evaluating an artificial intelligence assistant, the computerized system comprising:
one or more hardware processors;
memory;
a few-shot classifier executable by the one or more hardware processors and configured to receive, into the memory, feedback tuples, a list of topics of the artificial intelligence assistant, and a few-shot prompt, wherein each feedback tuple include a question, a corresponding answer generated by the artificial intelligence assistant, and qualitative feedback corresponding to the question and the corresponding answer, the few-shot classifier being further configured to output derived feature data including multiple derived features, after inputting the feedback tuples, the list of topics, and the few-shot prompt to the few-shot classifier;
a quantitative feature characterizer executable by the one or more hardware processors and configured to generate a feature-target training dataset by combining the multiple derived features with metafeatures corresponding to each question-answer pair of the derived feature data and adding a quantitative feedback target corresponding to each question-answer pair of the derived feature data;
a model trainer executable by the one or more hardware processors and configured to generate an attribution model by training the attribution model using the feature-target training dataset to yield a trained attribution model; and
a feature importance extractor executable by the one or more hardware processors and configured to extract feature importance vectors from the trained attribution model, wherein each feature importance vector indicates a relative importance of a given feature of the feature-target training dataset on a corresponding target of the feature-target training dataset.

9. The computerized system of claim 8, wherein the qualitative feedback includes free-text feedback.

10. The computerized system of claim 8, wherein the multiple derived features include a question-answer pair, a topic of the artificial intelligence assistant used to generate an answer for the question-answer pair, and an efficacy score corresponding to the answer and based on the qualitative feedback.

11. The computerized system of claim 10, wherein the efficacy score is generated by the few-shot classifier based on a feedback tuple and a few-shot prompt including efficacy scoring examples corresponding to example derived features.

12. The computerized system of claim 8, wherein the feature-target training dataset includes a derived feature of the multiple derived features, one or more corresponding metafeatures, and quantitative feedback.

13. The computerized system of claim 12, wherein the multiple derived features include a topic of the artificial intelligence assistant and an efficacy score corresponding to a corresponding question-answer pair.

14. The computerized system of claim 12, wherein each metafeature includes telemetry data corresponding to a corresponding question-answer pair.

15. One or more tangible processor-readable storage media embodied with instructions for executing on one or more processors and circuits of a computing device a process for evaluating an artificial intelligence assistant, the process comprising:
collecting feedback tuples and a list of topics of the artificial intelligence assistant, wherein each feedback tuple include a question, a corresponding answer generated by the artificial intelligence assistant, and qualitative feedback corresponding to the question and the corresponding answer;
outputting, from a few-shot classifier, derived feature data including multiple derived features, after inputting the feedback tuples, the list of topics, and a few-shot prompt to the few-shot classifier;
generating a feature-target training dataset by combining the multiple derived features with metafeatures corresponding to each question-answer pair of the derived feature data and adding a quantitative feedback target corresponding to each question-answer pair of the derived feature data;
generating an attribution model by training the attribution model using the feature-target training dataset to yield a trained attribution model; and
extracting feature importance vectors from the trained attribution model, wherein each feature importance vector indicates a relative importance of a given feature of the feature-target training dataset on a corresponding target of the feature-target training dataset.

16. The one or more tangible processor-readable storage media of claim 15, wherein the multiple derived features include a question-answer pair, a topic of the artificial intelligence assistant used to generate an answer for the question-answer pair, and an efficacy score corresponding to the answer and based on the qualitative feedback.

17. The one or more tangible processor-readable storage media of claim 16, wherein the efficacy score is generated using the few-shot classifier based on a feedback tuple and a few-shot prompt including efficacy scoring examples corresponding to example derived features.

18. The one or more tangible processor-readable storage media of claim 15, wherein the feature-target training dataset includes derived features, one or more corresponding metafeatures, and quantitative feedback.

19. The one or more tangible processor-readable storage media of claim 18, wherein the multiple derived features include a topic of the artificial intelligence assistant and an efficacy score corresponding to a corresponding question-answer pair.

20. The one or more tangible processor-readable storage media of claim 18, wherein each metafeature includes telemetry data corresponding to a corresponding question-answer pair.
